(19) United States
(12) Patent Application Publication
(10) Pub. No.: US 2025/0300688 A1
(43) Pub. Date: Sep. 25, 2025

(54) SPATIAL SEPARATION OF ANTENNAS WITH RADIO FREQUENCY EXPOSURE COMPLIANCE

(71) Applicant: QUALCOMM Incorporated, San Diego, CA (US)

(72) Inventors: Nandhini SRINIVASAN, San Diego, CA (US); Jagadish NADAKUDUTI, Bermuda Dunes, CA (US); Lin LU, San Diego, CA (US)

(21) Appl. No.: 19/084,297

(22) Filed: Mar. 19, 2025

Related U.S. Application Data
(60) Provisional application No. 63/567,897, filed on Mar. 20, 2024.

(51) Int. Cl. H04B 1/3827; H04B 7/06

(52) U.S. Cl. CPC H04B 1/3838; H04B 7/0602

(57) ABSTRACT

Techniques and apparatus for radio frequency (RF) exposure with antenna grouping are described. An example method that may be performed by a computing device includes obtaining, for a wireless device's surface, RF exposure map(s) associated with beams corresponding to a first antenna. The RF exposure map(s) indicate locations on the surface that are associated with maximum RF exposure(s). An RF exposure compliance exemption procedure is performed for the first antenna and a second antenna using a region associated with the locations. The exemption procedure involves computing RF exposure compliance exemption metrics for the region. A total number of the RF exposure compliance exemption metrics is less than a total number of the locations. Antenna grouping for at least the first and second antennas is performed, based on the exemption procedure.

### CROSS-REFERENCE TO RELATED APPLICATION

This application claims the benefit of U.S. Provisional Patent Application Ser. No. 63/567,897, filed Mar. 20, 2024, which is hereby incorporated by reference herein in its entirety for all applicable purposes.

### INTRODUCTION

### Field of the Disclosure

Aspects of the present disclosure relate to wireless communications, and more particularly, to antenna grouping with radio frequency (RF) exposure compliance.

### Description of Related Art

Wireless communication systems are widely deployed to provide various telecommunication services such as telephony, video, data, messaging, broadcasts, etc. Modern wireless devices (such as cellular telephones) are generally mandated to meet radio frequency (RF) exposure limits set by certain governments and international standards and regulations. To ensure compliance with the standards, such devices typically undergo an extensive certification process prior to being shipped to market. To ensure that a wireless device complies with an RF exposure limit, techniques have been developed to enable the wireless device to assess RF exposure from the wireless device and adjust the transmission power of the wireless device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance while complying with radio frequency (RF) exposure limits.

Certain aspects of the subject matter described in this disclosure can be implemented in a method for wireless device assessment. The method generally includes obtaining, for at least one surface of a wireless device, one or more radio frequency (RF) exposure maps associated with a plurality of beams corresponding to at least one first antenna. The one or more RF exposure maps indicate one or more locations on the at least one surface that are associated with one or more maximum RF exposures. The method also includes determining, for the at least one surface, at least one region associated with the one or more locations on the at least one surface that are associated with the one or more maximum RF exposures. The method also includes performing an RF exposure compliance exemption procedure for the at least one first antenna and at least one second antenna using the at least one region. Performing the RF exposure compliance exemption procedure includes computing one or more RF exposure compliance exemption metrics for the at least one region. A total number of the one or more RF exposure compliance exemption metrics is less than a total number of the one or more locations that are associated with the at least one region. The method also includes performing antenna grouping for a plurality of antennas, comprising the at least one first antenna and the at least one second antenna, based on the RF exposure compliance exemption procedure.

Certain aspects of the subject matter described in this disclosure can be implemented in an apparatus for wireless device assessment. The apparatus generally includes one or more memories collectively storing executable instructions, and one or more processors coupled to the one or more memories. The one or more processors are collectively configured to execute the executable instructions to cause the apparatus to: obtain, for at least one surface of a wireless device, one or more radio frequency (RF) exposure maps associated with a plurality of beams corresponding to at least one first antenna, the one or more RF exposure maps indicating one or more locations on the at least one surface that are associated with one or more maximum RF exposures; determine, for the at least one surface, at least one region associated with the one or more locations on the at least one surface that are associated with the one or more maximum RF exposures; perform an RF exposure compliance exemption procedure for the at least one first antenna and at least one second antenna using the at least one region, wherein, to perform the RF exposure compliance exemption procedure, the one or more processors are collectively configured to execute the instructions to cause the apparatus to compute one or more RF exposure compliance exemption metrics for the at least one region, wherein a total number of the one or more RF exposure compliance exemption metrics is less than a total number of the one or more locations that are associated with the at least one region; and perform antenna grouping for a plurality of antennas, comprising the at least one first antenna and the at least one second antenna, based on the RF exposure compliance exemption procedure.

Certain aspects of the subject matter described in this disclosure can be implemented in an apparatus for wireless device assessment. The apparatus generally includes means for obtaining, for at least one surface of a wireless device, one or more radio frequency (RF) exposure maps associated with a plurality of beams corresponding to at least one first antenna, the one or more RF exposure maps indicating one or more locations on the at least one surface that are associated with one or more maximum RF exposures. The apparatus also includes means for determining, for the at least one surface, at least one region associated with the one or more locations on the at least one surface that are associated with the one or more maximum RF exposures. The apparatus also includes means for performing an RF exposure compliance exemption procedure for the at least one first antenna and at least one second antenna using the at least one region. The means for performing includes means for computing one or more RF exposure compliance exemption metrics for the at least one region. A total number of the one or more RF exposure compliance exemption metrics is less than a total number of the one or more locations that are associated with the at least one region. The apparatus also includes means for performing antenna grouping for a plurality of antennas, comprising the at least one first antenna and the at least one second antenna, based on the RF exposure compliance exemption procedure.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network.

FIG. 2 is a block diagram conceptually illustrating a design of an example base station (BS) and user equipment (UE).

FIG. 3 is a block diagram of an example radio frequency (RF) transceiver.

FIGS. 4A, 4B, and 4C are graphs illustrating examples of transmit powers over time in compliance with a time-averaged RF exposure limit.

FIG. 5 is a diagram illustrating an example system for measuring RF exposure values or distributions.

FIG. 6 is a flow diagram illustrating example operations for generating an RF exposure map, in accordance with certain aspects of the present disclosure.

FIG. 7 illustrates an example table of maximum normalized RF exposure values for a surface of a wireless communication device, in accordance with certain aspects of the present disclosure.

FIG. 8 is a diagram illustrating exposure maps associated with a transmit scenario, in accordance with certain aspects of the present disclosure.

FIG. 9 is a flow diagram illustrating example operations for performing antenna grouping, in accordance with certain aspects of the present disclosure.

FIG. 10 illustrates a computing device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for complying with radio frequency (RF) exposure based on antenna groups.

In certain cases, RF exposure compliance testing for one or more transmit scenarios supported by a wireless communication device may be exempted, based on an RF exposure compliance exemption procedure. Such an RF exposure compliance exemption procedure may involve computing (or determining) one or more RF exposure compliance exemption metrics for the transmit scenario(s) supported by the wireless communication device. The RF exposure compliance testing for a given transmit scenario may be exempted when the one or more RF exposure compliance exemption metrics satisfy certain conditions (or criteria) specified by a standard and/or regulatory body (e.g., the Federal Communications Commission (FCC)).

One example of an RF exposure compliance exemption procedure may include a specific absorption ratio (SAR)-to-peak location separation ratio (SPLSR) exemption procedure, which involves computing one or more SPLSRs (e.g., RF exposure compliance exemption metrics) for each transmit scenario supported by a wireless communication device. As discussed further below, a transmit scenario may correspond to various combinations of radios, communication technologies (e.g., radio access technologies (RATs)), antennas, antenna groupings, antenna configurations (or beams) (e.g., transmit beam configuration), single-input, single-output (SISO) or multiple-input, multiple-output (MIMO) transmissions, operating conditions, frequency bands, RF exposure scenarios (e.g., head exposure, body-worn exposure, extremity (hand) exposure, and/or hotspot exposure), body positions, device use-case scenarios (e.g., based on active applications on the device, such as voice vs. data applications, gaming vs. video-call applications active on the device), physical configurations of a device (e.g., folded, closed, unfolded, open), and/or geographical locations or regions (e.g., countries or regions), as illustrative, non-limiting examples.

In certain aspects described herein, antennas associated with the wireless communication device may be grouped, for example, using an RF exposure compliance exemption procedure, such as an SPLSR exemption procedure. For example, in general, a pair of antennas may be considered to be spatially separated when the RF exposure compliance exemption metrics for a transmit scenario associated with the pair of antennas satisfy certain conditions (or criteria) specified by a standard and/or regulatory body. When such conditions for the pair of antennas are met, each antenna may be allocated to a different antenna group or may not be grouped at all, allowing the wireless communication device to perform RF exposure management for each antenna group or antenna independently.

For example, the antenna groups may be configured and/or operated so as to be mutually exclusive of each other in terms of RF exposure. That is, the RF exposure produced by one antenna group (with one or more antennas) may not contribute to the RF exposure produced by another antenna group (with one or more antennas), for example, due to the antenna groups being arranged in different locations of the wireless device. The RF exposure compliance and corresponding transmit power levels may be determined separately for each antenna group allowing for multiple antenna groups to transmit in the same time period.

One potential drawback to using an RF exposure compliance exemption procedure to group antennas is that it can take a significant amount of time and/or compute resources to implement the RF exposure compliance exemption procedure for certain types of antennas, such as millimeter wave (mmWave) (or mmW) antennas. For example, implementing the RF exposure compliance exemption procedure for a mmW module (having one or more mmW antennas or having a mmW antenna array) may involve computing an RF exposure compliance exemption metric (e.g., an SPLSR) for each beam and beam pair (e.g., transmit antenna configuration) supported by the mmW module.

In an illustrative example, assuming (i) the wireless communication device supports a mmW module and a sub-6 gigahertz (GHz) antenna, (ii) the RF exposure compliance exemption procedure is an SPLSR exemption procedure, and (iii) there are N beams supported by the mmW module, then the SPLSR exemption procedure may involve computing N SPLSR metrics to (i) demonstrate exemption from RF exposure compliance testing for the mmW module and/or sub-6 GHz antenna and (ii) determine one or more antenna groups for the mmW module and sub-6 GHz antenna.

In another illustrative example, assuming (i) the wireless communication device supports a first mmW module capable of transmitting with N1 beams and supports a second mmW module capable of transmitting with N2 beams and (ii) the RF exposure compliance exemption procedure is an SPLSR exemption procedure, then the SPLSR exemption procedure may involve computing N1*N2 SPLSR metrics to (i) demonstrate exemption from RF exposure compliance testing for the first mmW module and/or second mmW module and (ii) determine one or more antenna groups for the first mmW module and second mmW module.

Given the significant number of beams supported by a mmW module (e.g., a mmW module can support hundreds of beams), using conventional RF exposure compliance exemption procedures to perform antenna grouping can involve a significant amount of time and compute resources.

Certain aspects described herein provide techniques and apparatus for grouping antennas using an optimized (or at least reduced) RF exposure compliance exemption procedure. Compared to conventional RF exposure compliance exemption procedures, the optimized (or at least reduced) RF exposure compliance exemption procedure may involve computing a reduced number of RF exposure compliance exemption metrics to demonstrate exemption from RF exposure compliance testing for certain antennas of the wireless communication device (e.g., mmW antennas).

For example, in certain aspects, one or more RF exposure maps associated with antennas of the wireless communication device may be obtained for the wireless device. The RF exposure map(s) may be representative of the RF exposure in terms of specific absorption rate (SAR) and/or power density (PD). In certain aspects, the RF exposure map(s) may indicate one or more locations on at least one surface of the wireless communication device that are associated with one or more maximum RF exposures for certain transmit scenario combinations (e.g., beam combinations).

As described in greater detail herein, in certain aspects, one or more RF exposure regions associated with the location(s) that exhibit the maximum RF exposure(s) may be determined based at least in part on the RF exposure map(s). An optimized (or at least reduced) RF exposure compliance exemption procedure may then be performed for at least two antennas of the wireless communication device using the RF exposure region(s). For example, the optimized (or at least reduced) RF exposure compliance exemption procedure may involve computing one or more RF exposure compliance exemption metrics (e.g., SPLSRs) for each respective RF exposure region.

In certain aspects, for at least one of the RF exposure regions, the total number of the RF exposure compliance exemption metrics for the RF exposure region may be less than a total number of the location(s) associated with the RF exposure region. For example, the optimized (or at least reduced) RF exposure compliance exemption procedure described herein may use the RF exposure region(s) to represent the supported number of beams (e.g., N beams) of a mmW module with a smaller number of maximum RF exposure-based regions (e.g., M regions, where M<N). The optimized (or at least reduced) RF exposure compliance exemption procedure may compute RF exposure compliance exemption metrics for the smaller number of maximum RF exposure-based regions in order to perform antenna grouping. The wireless communication device may transmit a signal according to the antenna group in compliance with an RF exposure limit, e.g., set by country-specific regulations and/or international standards as further described herein.

The apparatus and methods for performing antenna grouping using an optimized (or at least reduced) RF exposure compliance exemption procedure described herein may facilitate improved wireless communication performance (e.g., improved signal quality at the receiver, lower latencies, higher throughput, etc.). The apparatus and methods for performing antenna grouping using an optimized (or at least reduced) RF exposure compliance exemption procedure described herein may also enable improved processing performance, for example, due to the reduced memory size used by the RF exposure region(s) and/or the reduced number of computations used to perform the RF exposure compliance exemption procedure to determine one or more antenna groups.

Aspects are described below in relation to modules (e.g., antenna modules, such as mmW modules). It will be appreciated, however, that techniques described herein may be implemented for antenna arrays which are not packaged into a module. Thus, the term “module” is not limiting to the scope of the application, but is used for illustrative purposes. Further, while mmW is used as an example, antennas and/or arrays configured for transmissions at different frequencies (e.g., frequency range 3 (FR3), such as in the 8-14 GHz range, sub-terahertz (sub-TH2), etc.) may be used.

As used herein, a radio may refer to a physical or logical transmission path associated with one or more active frequency bands, transceivers, and/or RATs (e.g., radio frequency identification (RFID) RATs, Second Generation (2G) RATs or Third Generation (3G) RATs such as code division multiple access (CDMA), Fourth Generation (4G) RATs such as Long Term Evolution (LTE), Fifth Generation (5G) New Radio (NR), Institute for Electrical and Electronics Engineers (IEEE) 802.11, Bluetooth, non-terrestrial network (NTN) communications, etc.) used for wireless communications. For example, for uplink carrier aggregation in LTE and/or NR, each of the active component carriers used for wireless communications may be treated as a separate radio. Similarly, multi-band transmissions for IEEE 802.11 communications may be treated as separate radios for each band (e.g., 2.4 GHz, 5 GHZ, or 6 GHZ). In some examples, a radio is defined based on a RAT and/or frequency for the purposes of RF exposure determination and/or RF exposure compliance.

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with 3G, 4G, and/or New Radio (e.g., 5G NR) wireless technologies, aspects of the present disclosure can be applied in other generation-based communication systems and/or to wireless technologies such as 802.11, 802.15, NTN communications, etc.

NR access may support various wireless communication services, such as enhanced mobile broadband (eMBB) targeting wide bandwidth (e.g., 80 megahertz (MHz) or beyond), millimeter wave (mmWave) targeting high carrier frequency (e.g., 24 GHz to 53 GHz or beyond), massive machine type communications (MTC) (mMTC) targeting non-backward compatible MTC techniques, and/or mission critical targeting ultra-reliable low-latency communications (URLLC). These services may include latency and reliability specifications. These services may also have different transmission time intervals (TTIs) to meet respective quality of service (QOS) specifications. In addition, these services may co-exist in the same subframe. NR supports beamforming, and beam direction may be dynamically configured. Multiple-input, multiple-output (MIMO) transmissions with precoding may also be supported, as may multi-layer transmissions. Aggregation of multiple cells may be supported.

Although the terms “first,” “second,” “third,” etc., may be used herein to describe various devices, elements, components, regions, layers and/or sections, these devices, elements, components, regions, layers and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

### Example Wireless Communication Network and Devices

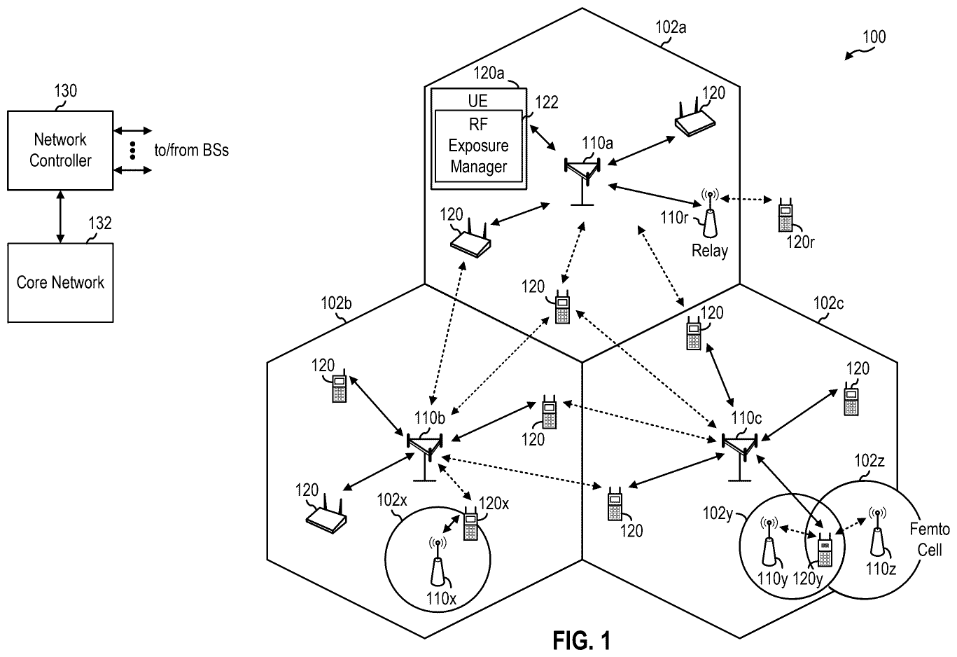

FIG. 1 illustrates an example wireless communication network 100 in which aspects of the present disclosure may be performed. For example, the wireless communication network 100 may be an RFID system, an NR system (e.g., a 5G NR network), an Evolved Universal Terrestrial Radio Access (E-UTRA) system (e.g., a 4G network), a Universal Mobile Telecommunications System (UMTS) (e.g., a 2G/3G network), or a CDMA system (e.g., a 2G/3G network), or may be configured for communications according to an IEEE standard such as one or more of the 802.11 standards, etc. As shown in FIG. 1, the UE 120a includes a RF exposure manager 122 that ensures RF exposure compliance using an optimized (or at least reduced) RF exposure compliance exemption procedure, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 1022, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In some aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

The term “beam” may be used in the present disclosure in various contexts. Beam may be used to mean a set of gains and/or phases (e.g., pre-coding weights or co-phasing weights) applied to antenna elements in the UE and/or BS for transmission or reception. The term “beam” may also refer to an antenna or radiation pattern of a signal transmitted while applying the gains and/or phases to the antenna elements. Other references to beam may include one or more properties or parameters associated with the antenna (radiation) pattern, such as angle of arrival (AoA), angle of departure (AoD), gain, phase, directivity, beam width, beam direction (with respect to a plane of reference) in terms of azimuth and elevation, peak-to-side-lobe ratio, or an antenna port associated with the antenna (radiation) pattern. The term “beam” may also refer to an associated number and/or configuration of antenna elements (e.g., a uniform linear array, a uniform rectangular array, or other uniform array). Additionally, as used herein, the term “beam pair” may refer to any combination of “beams.”

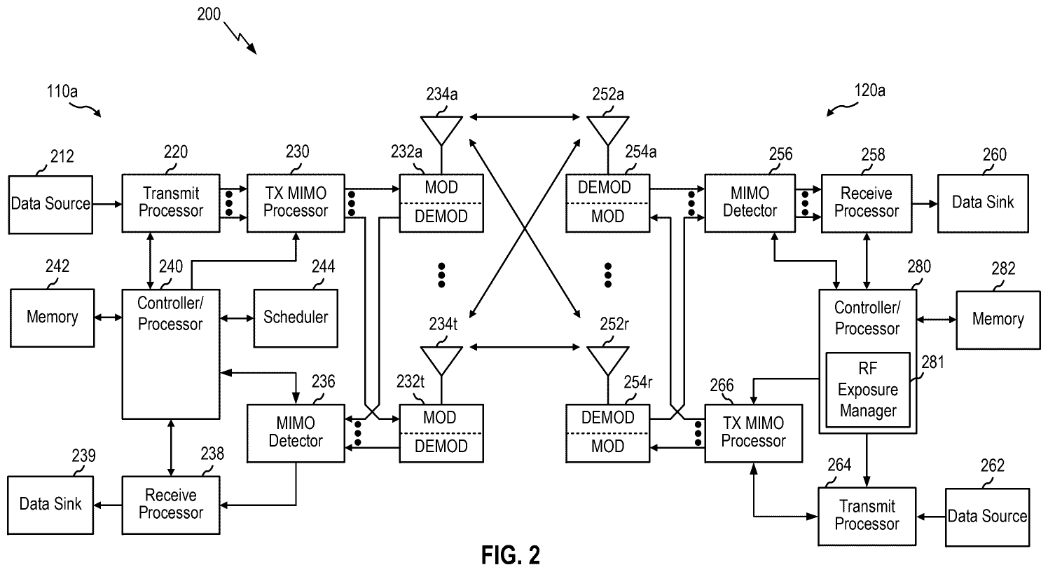

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has an RF exposure manager 281 that is representative of the RF exposure manager 122, according to aspects described herein. Although shown at the controller/processor, other components of the UE 120a and BS 110a may be used to perform the operations described herein.

NR may utilize OFDM with a cyclic prefix (CP) on the uplink and downlink. NR may support half-duplex operation using time division duplexing (TDD). OFDM and SC-FDM partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some aspects, the BS 110a illustrated in FIG. 2 and described above is an example of another UE 120.

### Example RF Transceiver

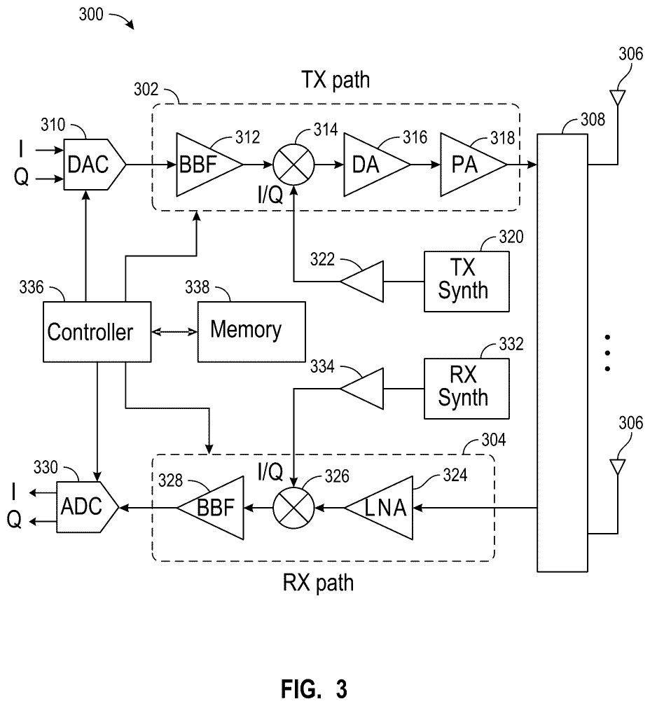

FIG. 3 is a block diagram of an example RF transceiver circuit 300, in accordance with certain aspects of the present disclosure. The RF transceiver circuit 300 includes at least one transmit (TX) path 302 (also known as a transmit chain) for transmitting signals via one or more antennas 306 and at least one receive (RX) path 304 (also known as a receive chain) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, and the DA 316 may be included in one or more radio frequency integrated circuits (RFICs). The PA 318 may be external to the RFIC(s) for some implementations.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 314 are typically RF signals, which may be amplified by the DA 316 and/or by the PA 318 before transmission by the antenna 306. While one mixer 314 is illustrated, several mixers may be used to upconvert the filtered baseband signals to one or more intermediate frequencies and to thereafter upconvert the intermediate frequency signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I or Q signals for digital signal processing.

Certain transceivers may employ frequency synthesizers with a voltage-controlled oscillator (VCO) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326.

A controller 336 may direct the operation of the RF transceiver circuit 300, such as transmitting signals via the TX path 302 and/or receiving signals via the RX path 304. The controller 336 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 338 may store data and program codes for operating the RF transceiver circuit 300. The controller 336 and/or memory 338 may include control logic. In certain cases, the controller 336 may determine a transmit power applied to the TX path 302 (e.g., certain levels of gain applied to the BBF 312, the DA 316, and/or PA 318) that complies with an RF exposure limit set by country-specific regulations and/or international standards as further described herein.

### Example RF Exposure Compliance

RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless devices using transmission frequencies above 6 GHz. The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change.

SAR may be used to assess RF exposure for transmission frequencies less than 6 GHz, which cover wireless communication technologies such as 2G/3G (e.g., CDMA), 4G (e.g., LTE), 5G (e.g., NR in 6 GHz bands), IEEE 802.11ac, NTN, etc. PD may be used to assess RF exposure for transmission frequencies higher than 6 GHZ, which cover wireless communication technologies such as IEEE 802.11ad, 802.11ay, 5G in mmWave bands, etc. Absorbed power density (APD) may be used to assess RF exposure for transmission frequencies less than and greater than 6 GHz. Thus, different metrics may be used to assess RF exposure for different wireless communication technologies, e.g., depending on country-specific regulations and/or international standards.

A wireless device (e.g., UE 120) may simultaneously transmit signals using multiple wireless communication technologies. For example, the wireless device may simultaneously transmit signals using a first wireless communication technology operating at or below 6 GHZ (e.g., 3G, 4G, 5G, etc.) and a second wireless communication technology operating above 6 GHZ (e.g., mmWave 5G in 24 to 60 GHz bands, IEEE 802.11ad or 802.11ay). In certain aspects, the wireless device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.1 lay, etc.) in which RF exposure is measured in terms of PD or APD. As used herein, sub-6 GHz bands may include frequency bands of 300 MHz to 6,000 MHz in some examples, and may include bands in the 6,000 MHz and/or 7,000 MHz range in some examples.

To assess RF exposure from transmissions using the first technology (e.g., 3G, 4G, 5G in sub-6 GHz bands, IEEE 802.11ac, NTN, etc.), the wireless communication device may include multiple SAR values and/or SAR distributions for the first technology stored in memory (e.g., memory 282 of FIG. 2 or memory 338 of FIG. 3). Each of the SAR values and/or SAR distributions may correspond to a respective one of multiple transmit scenarios supported by the wireless communication device for the first technology. The transmit scenarios may correspond to various combinations of radios, communication technologies (e.g., RATs), antennas (e.g., antennas 252a through 252r of FIG. 2 or antenna 306 of FIG. 3), antenna groupings, frequency bands, SISO or MIMO transmissions, operating conditions, antenna configurations (or beams) (e.g., transmit beam configuration), RF exposure scenarios, body positions, device use-case scenarios, physical configurations of a device (e.g., folded, closed, unfolded, open), and/or geographical locations or regions, as discussed further below. In some examples, the stored SAR value and/or distribution includes a single value (e.g., a peak value determined based on the description below, or a sum of peak values).

The SAR values and/or SAR distribution (also referred to as a SAR map) for each transmit scenario may be generated based on measurements (e.g., E-field measurements) performed in a test laboratory using a model of a human body. After generation, the SAR values and/or SAR distribution may be stored in the memory to enable a processor (e.g., processor 280 of FIG. 2 and/or controller 336 of FIG. 3) to assess RF exposure in real time, as discussed further below. Each SAR distribution may include a set of SAR values, where each SAR value may correspond to a different location (e.g., on the model of the human body). Each SAR value may comprise a SAR value averaged over a mass of 1 g or 10 g at the respective location.

The SAR values in each SAR distribution correspond to a particular transmission power level (e.g., the transmission power level at which the SAR values were measured in the test laboratory). Since SAR scales with transmission power level, the processor may scale a SAR value or SAR distribution for any transmission power level by multiplying each SAR value (e.g., in the SAR distribution) by the following transmission power scaler:

$$\frac{T {x}_{c}}{T {x}_{SAR}} \qquad ( 1 )$$

where Tx_{c} is a current transmission power level for the respective transmit scenario, and Tx_{SAR} is the transmission power level corresponding to the SAR values (e.g., the transmission power level at which the SAR values were measured in the test laboratory).

As discussed above, the wireless communication device may support multiple transmit scenarios for the first technology. In certain aspects, the transmit scenarios may be specified by a set of parameters. The set of parameters may include one or more of the following: an antenna parameter indicating one or more antennas used for transmission (i.e., active antennas), a frequency band parameter indicating one or more frequency bands used for transmission (i.e., active frequency bands), a channel parameter indicating one or more channels used for transmission (i.e., active channels), a body position parameter (e.g., a device state index (DSI)) indicating the location of the wireless communication device relative to the user's body location (head, trunk, away from the body, etc.), exposure category, a beam parameter, and/or other parameters. In cases where the wireless communication device supports a large number of transmit scenarios, it may be very time-consuming and expensive to perform measurements for each transmit scenario in a test setting (e.g., test laboratory). To reduce test time, measurements may be performed for a subset of the transmit scenarios to generate SAR values and/or SAR distributions for the subset of transmit scenarios. In this example, the SAR values and/or SAR distributions for each of the remaining transmit scenarios may be generated by combining two or more of the SAR values and/or SAR distributions for the subset of transmit scenarios, as discussed further below.

For example, SAR measurements may be performed for each one of the antennas to generate a SAR value or SAR distribution for each one of the antennas. In this example, a SAR value or SAR distribution for a transmit scenario in which two or more of the antennas are active may be generated by combining the SAR values or SAR distributions for the two or more active antennas.

In another example, SAR measurements may be performed for each one of multiple frequency bands to generate a SAR value or SAR distribution for each one of the multiple frequency bands. In this example, a SAR value or SAR distribution for a transmit scenario in which two or more frequency bands are active may be generated by combining the SAR values or SAR distributions for the two or more active frequency bands.

In certain aspects, a SAR distribution may be normalized with respect to a SAR limit by dividing each SAR value in the SAR distribution by the SAR limit. In this case, a normalized SAR value exceeds the SAR limit when the normalized SAR value is greater than one, and is below the SAR limit when the normalized SAR value is less than one. In these aspects, each of the SAR distributions stored in the memory may be normalized with respect to a SAR limit. Similarly, a single or individual SAR value may be normalized with respect to a SAR limit. In some cases, the SAR limit may correspond to a regulatory or standardized limit or may correspond to a level lower than the regulatory or standardized limit to provide sufficient exposure margin to account for device uncertainties and/or other margins (for example, for other radios).

In certain aspects, the normalized SAR value or normalized SAR distribution for a transmit scenario may be generated by combining two or more normalized SAR values or normalized SAR distributions. For example, a normalized SAR value or normalized SAR distribution for a transmit scenario in which two or more antennas are active may be generated by combining the normalized SAR values or normalized SAR distributions for the two or more active antennas. For the case in which different transmission power levels are used for the active antennas, the normalized SAR value or normalized SAR distribution for each active antenna may be scaled by the respective transmission power level before combining the normalized SAR values or normalized SAR distributions for the active antennas. The normalized SAR value or normalized SAR distribution for simultaneous transmission from multiple active antennas may be given by the following:

$${SAR}_{norm\_combined} = {\sum }_{i = 1}^{i = K} \frac{T {x}_{i}}{T {x}_{SARi}} \cdot \frac{{SAR}_{i}}{{SAR}_{lim}} \qquad ( 2 )$$

where SARₗᵢₘ is a SAR limit, SAR_{norm_combined} is the combined normalized SAR value or combined normalized SAR distribution for simultaneous transmission from the active antennas, i is an index for the active antennas, SARᵢ is the SAR value or SAR distribution for the i^{th} active antenna, Txᵢ is the transmission power level for the i^{th} active antenna, Tx_{SARi} is the transmission power level for the SAR distribution for the i^{th} active antenna, and K is the number of the active antennas.

Equation (2) may be rewritten as follows:

$${SAR}_{norm\_combined} = {\sum }_{i = 1}^{i = K} \frac{{Tx}_{i}}{{Tx}_{SARi}} \cdot {SAR}_{norm\_i} \qquad ( 3 a )$$

where SAR_{norm_i} is the normalized SAR value or normalized SAR distribution for the i^{th} active antenna. In the case of simultaneous transmissions using multiple active antennas at the same transmitting frequency (e.g., multiple-input, multiple-output (MIMO)), the combined normalized SAR value or combined normalized SAR distribution may be obtained by summing the square root of the individual normalized SAR values or normalized SAR distributions and computing the square of the sum, as given by the following:

$${SAR}_{norm\_combined \_MIMO} = {[ {\sum }_{i = 1}^{i = K} \sqrt{\frac{{Tx}_{i}}{{Tx}_{SARi}} \cdot {SAR}_{norm\_i}} ]}^{2} . \qquad ( 3 b )$$

In another example, normalized SAR values or normalized SAR distributions for different frequency bands may be stored in the memory. In this example, a normalized SAR distribution for a transmit scenario in which two or more frequency bands are active may be generated by combining the normalized SAR distributions for the two or more active frequency bands. For the case where the transmission power levels are different for the active frequency bands, the normalized SAR value or normalized SAR distribution for each of the active frequency bands may be scaled by the respective transmission power level before combining the normalized SAR values or normalized SAR distributions for the active frequency bands. In this example, the combined SAR value or combined SAR distribution may also be computed using Equation (3a) in which i is an index for the active frequency bands, SAR_{norm_i} is the normalized SAR value or normalized SAR distribution for the i^{th} active frequency band, Txᵢ is the transmission power level for the i^{th} active frequency band, and Tx_{SARi} is the transmission power level for the normalized SAR value or normalized SAR distribution for the i^{th} active frequency band.

To assess RF exposure from transmissions using the second technology (e.g., 5G in 24 to 60 GHz bands, IEEE 802.11ad, 802.11ay, etc.), the wireless communication device may include multiple PD values and/or PD distributions for the second technology stored in the memory (e.g., memory 282 of FIG. 2 or memory 338 of FIG. 3). Each of the PD values or PD distributions may correspond to a respective one of multiple transmit scenarios supported by the wireless communication device for the second technology. The transmit scenarios may correspond to various combinations of radios, communication technologies (e.g., RATs), antennas (e.g., antennas 252a through 252r of FIG. 2 or antenna 306 of FIG. 3), antenna groupings, frequency bands, SISO or MIMO transmissions, operating conditions, antenna configurations (or beams) (e.g., transmit beam configuration), RF exposure scenarios, body positions, device use-case scenarios, physical configurations of a device (e.g., folded, closed, unfolded, open), and/or geographical locations or regions, as discussed further below. In some examples, the stored PD value and/or distribution includes a single value (e.g., a peak value determined based on the description below, or a sum of peak values).

The PD values and/or PD distribution (also referred to as a PD map) for each transmit scenario may be generated based on measurements (e.g., E-field measurements) performed in a test laboratory using a model of a human body. After generation, the PD distributions are stored in the memory to enable the processor (e.g., processor 280 of FIG. 2 or controller 336 of FIG. 3) to assess RF exposure in real time, as discussed further below. Each PD distribution may include a set of PD values, where each PD value may correspond to a different location (e.g., on the model of the human body).

The PD values in each PD distribution correspond to a particular transmission power level (e.g., the transmission power level at which the PD values were measured in the test laboratory). Since PD scales with transmission power level, the processor may scale a PD value or PD distribution for any transmission power level by multiplying each PD value (e.g., in the PD distribution) by the following transmission power scaler:

$$\frac{{Tx}_{c}}{{Tx}_{PD}} \qquad ( 4 )$$

where Tx_{c} is a current transmission power level for the respective transmit scenario, and Tx_{PD} is the transmission power level corresponding to the PD values (e.g., the transmission power level at which the PD values were measured in the test laboratory).

As discussed above, the wireless communication device may support multiple transmit scenarios for the second technology. In certain aspects, the transmit scenarios may be specified by a set of parameters. The set of parameters may include one or more of the following: an antenna parameter indicating one or more antennas used for transmission (i.e., active antennas), a frequency band parameter indicating one or more frequency bands used for transmission (i.e., active frequency bands), a channel parameter indicating one or more channels used for transmission (i.e., active channels), a body position parameter (e.g., a DSI) indicating the location of the wireless communication device relative to the user's body location (head, trunk, away from the body, etc.), exposure category, a beam parameter, and/or other parameters. In cases where the wireless communication device supports a large number of transmit scenarios, it may be very time-consuming and expensive to perform measurements for each transmit scenario in a test setting (e.g., test laboratory). To reduce test time, measurements may be performed for a subset of the transmit scenarios to generate PD values and/or PD distributions for the subset of transmit scenarios. In this example, the PD values and/or PD distributions for each of the remaining transmit scenarios may be generated by combining two or more of the PD values and/or PD distributions for the subset of transmit scenarios, as discussed further below. In some cases, a subset of PD distributions generated via measurements may be used to validate PD distributions obtained from electromagnetic simulation of a wireless communication device, such that the PD distributions may be obtained from simulation for all the transmit scenarios supported by the wireless communication device.

For example, PD measurements may be performed for each one of the antennas to generate a PD value or PD distribution for each one of the antennas. In this example, a PD value or PD distribution for a transmit scenario in which two or more of the antennas are active may be generated by combining the PD values or PD distributions for the two or more active antennas.

In another example, PD measurements may be performed for each one of multiple frequency bands to generate a PD value or PD distribution for each one of the multiple frequency bands. In this example, a PD value or PD distribution for a transmit scenario in which two or more frequency bands are active may be generated by combining the PD values or PD distributions for the two or more active frequency bands.

In yet another example, a validated electromagnetics simulation model that is configured according to one or more regulatory criteria may be used to generate a PD value or PD distribution for each one of the antennas or each one of multiple frequency bands. In this example, (i) a PD value or PD distribution for a transmit scenario in which two or more of the antennas are active may be generated by combining the PD values or PD distributions for the two or more active antennas or (ii) a PD value or PD distribution for a transmit scenario in which two or more frequency bands are active may be generated by combining the PD values or PD distributions for the two or more active frequency bands.

In certain aspects, a PD distribution may be normalized with respect to a PD limit by dividing each PD value in the PD distribution by the PD limit. In this case, a normalized PD value exceeds the PD limit when the normalized PD value is greater than one, and is below the PD limit when the normalized PD value is less than one. In these aspects, each of the PD distributions stored in the memory may be normalized with respect to a PD limit. Similarly, a single or individual PD value may be normalized with respect to a PD limit.

In certain aspects, the normalized PD value or normalized PD distribution for a transmit scenario may be generated by combining two or more normalized PD values or normalized PD distributions. For example, a normalized PD value or normalized PD distribution for a transmit scenario in which two or more antennas are active may be generated by combining the normalized PD values or normalized PD distributions for the two or more active antennas. For the case in which different transmission power levels are used for the active antennas, the normalized PD value or normalized PD distribution for each active antenna may be scaled by the respective transmission power level before combining the normalized PD values or normalized PD distributions for the active antennas. The normalized PD value or normalized PD distribution for simultaneous transmission from multiple active antennas may be given by the following:

$${PD}_{norm\_combined} = {\sum }_{i = 1}^{i = L} \frac{{Tx}_{i}}{{Tx}_{PDi}} \cdot \frac{{PD}_{i}}{{PD}_{lim}} \qquad ( 5 )$$

where PDₗᵢₘ is a PD limit, PD_{norm_combined} is the combined normalized PD value or combined normalized PD distribution for simultaneous transmission from the active antennas, i is an index for the active antennas, PDᵢ is the PD value or PD distribution for the i^{th} active antenna, Tx; is the transmission power level for the i^{th} active antenna, Tx_{PDi} is the transmission power level for the PD distribution for the i^{th} active antenna, and L is the number of the active antennas.

Equation (5) may be rewritten as follows:

$${PD}_{norm\_combined} = {\sum }_{i = 1}^{i = L} \frac{{Tx}_{i}}{{Tx}_{PDi}} \cdot {PD}_{norm\_i} \qquad ( 6 a )$$

where PD_{norm_i} is the normalized PD value or normalized PD distribution for the i^{th} active antenna. In the case of simultaneous transmissions using multiple active antennas at the same transmitting frequency (e.g., MIMO), the combined normalized PD value or combined normalized PD distribution may be obtained by summing the square root of the individual normalized PD values or individual normalized PD distributions and computing the square of the sum, as given by the following:

$$P {D}_{norm\_combined \_MIMO} = {[ {\sum }_{i = 1}^{i = L} \sqrt{\frac{{Tx}_{i}}{{Tx}_{PDi}} \cdot {PD}_{norm\_i}} ]}^{2} . \qquad ( 6 b )$$

In certain aspects, a composite normalized PD distribution for a given transmitting band can be obtained by taking the maximum value at a given location (x,y,z) out of all normalized PD distributions for all the antenna configurations of a mmWave module. The composite normalized PD distribution can be used to represent the PD distribution for all antenna configurations of a mmW antenna module:

$${PD}_{{norm}_{composite}} ( x , y , z ) = \frac{maximum \{ {PD}_{a} ( x , y , z ) , a = 1 … N \}}{{PD}_{lim}}$$

This PD_{norm_composite} can be used to substitute PD_{norm_i} in Equation (6a), where a represents all the N beams (or antenna configurations) supported by i^{th} mmWave module for a given frequency band. In such cases, Equation (6a) represents combining PD distributions if multiple frequency bands or mmWave antenna modules are active.

In another example, normalized PD values or normalized PD distributions for different frequency bands may be stored in the memory. In this example, a normalized PD value or normalized PD distribution for a transmit scenario in which two or more frequency bands are active may be generated by combining the normalized PD distributions for the two or more active frequency bands. For the case where the transmission power levels are different for the active frequency bands, the normalized PD value or normalized PD distribution for each of the active frequency bands may be scaled by the respective transmission power level before combining the normalized PD values or normalized PD distributions for the active frequency bands. In this example, the combined PD value or combined PD distribution may also be computed using Equation (6a) in which i is an index for the active frequency bands, PD_{norm_i} is the normalized PD value or normalized PD distribution for the i^{th} active frequency band, Txᵢ is the transmission power level for the i^{th} active frequency band, and Tx_{PDi} is the transmission power level for the normalized PD value or normalized PD distribution for the i^{th} active frequency band.

In certain cases, compliance with an RF exposure limit may be performed as a time-averaged RF exposure evaluation within a specified time window (T) (e.g., 2 seconds for 60 GHz bands, 100 or 360 seconds for bands ≤6 GHZ, etc.) associated with the RF exposure limit.

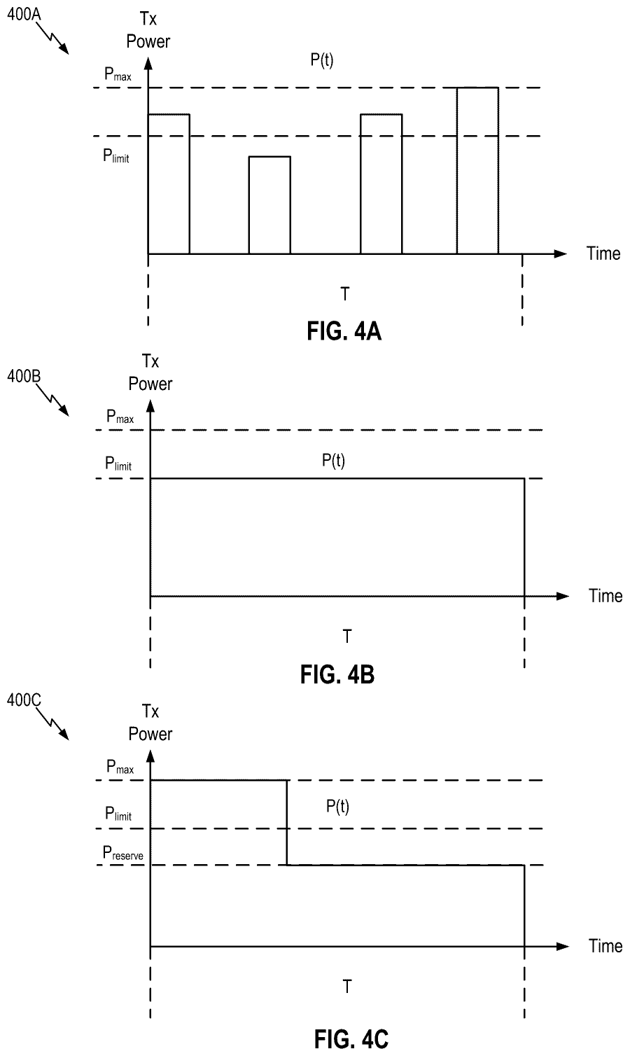

FIG. 4A is a graph 400A of a transmit power over time (P(t)) that varies over a time window (T) associated with the RF exposure limit, in accordance with certain aspects of the present disclosure. As an example, the instantaneous transmit power may exceed a maximum time-averaged transmit power level Pₗᵢₘᵢₜ in certain transmission occasions in the time window (T). That is, the transmit power may be greater than the maximum time-averaged transmit power level Pₗᵢₘᵢₜ. In certain cases, the UE may transmit at Pₘₐₓ, which is the maximum transmit power supported by the UE. In certain cases, the UE may transmit at a transmit power less than or equal to the maximum time-averaged transmit power level Pₗᵢₘᵢₜ in certain transmission occasions. The maximum time-averaged transmit power level Pₗᵢₘᵢₜ represents the time-averaged threshold in terms of transmit power for the RF exposure limit over the time window (T), and in certain cases, Pₗᵢₘᵢₜ may be referred to as the maximum time-averaged power level or limit, or in terms of exposure, the maximum time-averaged RF exposure level or limit. The graph 400A also illustrates gaps between transmission bursts, where the gaps represent periods during which no transmission was output from the device.

In certain cases, the transmit power may be maintained at the maximum time-averaged transmit power level (e.g., Pₗᵢₘᵢₜ) allowed for RF exposure compliance that enables continuous transmission during the time window. For example, FIG. 4B is a graph 400B of a transmit power over time (P(t)) illustrating an example where the transmit power is limited to Pₗᵢₘᵢₜ, in accordance with certain aspects of the present disclosure. As shown, the UE can transmit continuously at Pₗᵢₘᵢₜ in compliance with the RF exposure limit.

FIG. 4C is a graph 400C of a transmit power over time (P(t)) illustrating a time-averaged mode that provides a reserve power to enable a continuous transmission within the time window (T), in accordance with certain aspects of the present disclosure. As shown, the transmit power may be backed off from the maximum instantaneous power (Pₘₐₓ) to a reserve power (Pᵣₑₛₑᵣᵥₑ) so that the UE can continue transmitting at the lower power (Pᵣₑₛₑᵣᵥₑ) to maintain a continuous transmission during the time window (e.g., maintain a radio connection with a receiving entity). In FIG. 4C, the area between Pₘₐₓ and Preserve for the time duration of Pₘₐₓ may be equal to the area between Pₗᵢₘᵢₜ and Preserve for the time window T, such that the area of transmit power (P(t)) in FIG. 4C is equal to the area of Pₗᵢₘᵢₜ for the time window T. Such an area may be considered using 100% of the energy (transmit power or exposure) to remain compliant with the time-averaged RF exposure limit. Without the reserve power Preserve, the transmitter may transmit at Pₘₐₓ for a portion of the time window with the transmitter turned off for the remainder of the time window to ensure compliance with the time-averaged RF exposure limit. In some aspects, Preserve is set at a fixed power used to serve for a purpose (e.g., reserving power for certain communications). The transmit duration at Pₘₐₓ may be referred to as the burst transmit time (or high power duration). When more margin is available in the future (after T seconds), the transmitter may be allowed to transmit at a higher power again (e.g., in short bursts at Pₘₐₓ).

In some aspects, the UE may transmit at a power that is higher than the average power level, but less than Pₘₐₓ in the time-averaged mode illustrated in FIG. 4C. While a single transmit burst is illustrated in FIG. 4C, it will be understood that the UE may instead utilize a plurality of transmit bursts within the time window (T), for example, as described herein with respect to FIG. 4A, where the transmit bursts may be separated by periods during which the transmit power is maintained at or below Preserve. Further, it will be understood that the transmit power of each transmit burst may vary (either within the burst and/or in comparison to other bursts), and that at least a portion of the burst may be transmitted at a power above the maximum average power level (e.g., Pₗᵢₘᵢₜ).

While FIGS. 4A-4C illustrate continuous transmission over a window, occasion, burst, etc., it will be understood that a duty cycle for transmission may be implemented. In such implementations, a transmit power may be zero periodically and maintained at a higher level (e.g., a level as illustrated in FIGS. 4A-4C) during other portions of the duty cycle. As used herein, the duty cycle of the transmission may refer to a portion (e.g., 5 ms) of a specific period (e.g., 500 ms) in which one or more signals are transmitted. In certain cases, the duty cycle may be standardized (e.g., predetermined) with a specific RAT and/or vary over time, for example, due to changes in radio conditions, mobility, and/or user behavior.

### Example RF Exposure Measurements

In certain cases, the RF exposure of a wireless device may be certified with a regulatory agency (e.g., the FCC). Spatial measurements may be taken with respect to a model (phantom) representing the human body, where the model may be filled with a liquid simulating human tissue. As discussed above, the UE 120 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure distributions (simulation and/or measurement) may then be generated per transmit antenna/configuration (beam) (as described above) on all evaluation surfaces/positions at all locations. Note that while certain examples described herein use PD as an illustrative example of the second technology, in certain aspects, APD may be used for the second technology.

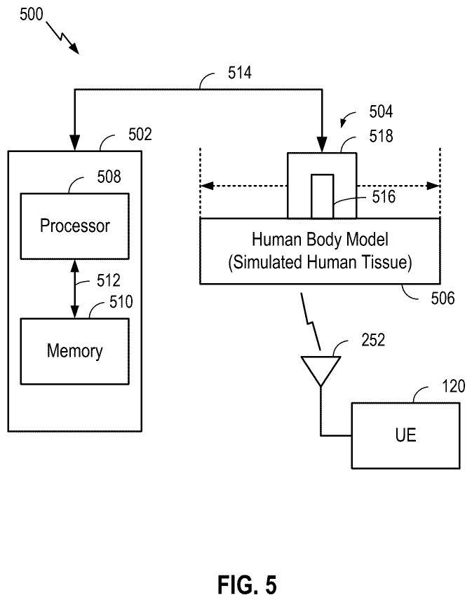

FIG. 5 is a diagram illustrating an example system 500 for measuring RF exposure values or distributions, in accordance with certain aspects of the present disclosure. As shown, the RF exposure measurement system 500 includes a processing system 502, a robotic RF probe 504, and a human body model 506. The RF exposure measurement system 500 may take RF measurements at various transmit scenarios and/or exposure scenarios associated with the UE 120. In some examples, these measurements may be used to generate a RF exposure map and assess suitable backoff factors for the transmit powers of the antenna(s) 252 in compliance with one or more RF exposure limits, as further described herein. The UE 120 may emit electromagnetic radiation via the antenna(s) 252 at various transmit powers, and the RF exposure measurement system 500 may take RF measurements via the robotic RF probe 504 (e.g., to determine RF exposure map(s) and/or backoff factors for the antenna(s) 252).

The processing system 502 may include a processor 508 coupled to a memory 510 via a bus 512. The processing system 502 may be a computational device such as a computer. The processor 508 may include a central processing unit (CPU), a graphics processing unit (GPU), a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 508 may be in communication with the robotic RF probe 504 via an interface 514 (such as a computer bus interface), such that the processor 508 may obtain RF measurements taken by the robotic RF probe 504 and control the position of the robotic RF probe 504 relative to the human body model 506, for example.

The memory 510 may be configured to store instructions (e.g., computer-executable code) that when executed by the processor 508, cause the processor 508 to perform various operations. For example, the memory 510 may store instructions for obtaining the RF exposure distributions associated with various RF exposure/transmit scenarios and/or adjusting the position of the robotic RF probe 504.

The robotic RF probe 504 may include an RF probe 516 coupled to a robotic arm 518. In some aspects, the RF probe 516 may be a dosimetric probe capable of measuring RF exposures at various frequencies such as sub-6 GHz bands and/or mmWave bands. The RF probe 516 may be positioned by the robotic arm 518 in various locations (as indicated by the dotted arrows) to capture the electromagnetic radiation emitted by the antenna(s) 252 of the UE 120. The robotic arm 518 may be a six-axis robot capable of performing precise movements to position the RF probe 516 to the location (on the human body model 506) of maximum electromagnetic field generated by the UE 120. In other words, the robotic arm 518 may provide six degrees of freedom in positioning the RF probe 516 with respect to the antenna(s) 252 of the UE 120 and/or the human body model 506.

The human body model 506 may be a specific anthropomorphic mannequin with simulated human tissue. For example, the human body model 506 may include one or more liquids that simulate the human tissue of the head, body, and/or extremities. The human body model 506 may simulate the human tissue for determining the maximum permissible transmission power of the antenna(s) 252 in compliance with various RF exposure limits.

In certain aspects, the RF exposure values or distributions associated with the UE 120 may be measured without the human body model 506. For example, the RF probe 516 may be an electric- or magnetic-field probe capable of estimating the SAR and/or PD in the free-space surrounding the UE 120.

While the example depicted in FIG. 5 is described herein with respect to obtaining RF exposure values or distributions with a robotic RF probe to facilitate understanding, aspects of the present disclosure may also be applied to other suitable RF probe architectures, such as using multiple stationary RF probes positioned at various locations along the human body model 506 or free-space.

In certain aspects, the RF exposure measurement system 500 may be used to generate one or more RF exposure maps. The RF exposure map(s) may indicate location(s) on surface(s) of a wireless communication device that exhibit one or more maximum RF exposures for certain transmit scenario combinations, as further described herein.

### Example Radio Frequency Exposure Compliance Exemption Procedure

RF exposure compliance testing for one or more transmit scenarios supported by a wireless communication device may be exempted, based on an RF exposure compliance exemption procedure. As noted, an RF exposure compliance exemption procedure may involve computing (or determining) one or more RF exposure compliance exemption metrics for the transmit scenario(s) supported by the wireless communication device. Total exposure ratio (TER) procedure is one example of an RF exposure compliance exemption procedure that may be used to exempt one or more transmit scenarios from simultaneous transmission testing (e.g., RF exposure compliance testing). The TER procedure may involve computing a TER (e.g., RF exposure compliance exemption metric) for one or more transmit scenarios supported by the wireless communication device. A TER (e.g., TER_{SAR-PD}) may be calculated by taking the ratio of reported SAR (for a transmit scenario) divided by the SAR limit and adding the ratio to the measured power density (for the transmit scenario) divided by the PD limit. In certain cases, when the TER for a given transmit scenario satisfies a condition specified by a standard and/or regulatory body (e.g., TER_{SAR-PD}<1), simultaneous transmission testing for that transmit scenario may be exempted.

In certain cases, when the exemption conditions associated with the TER procedure are not satisfied (e.g., TER_{SAR-PD}>1), simultaneous transmission testing for that transmit scenario may still be exempted, based on an SPLSR exemption procedure. With an SPLSR exemption procedure, the simultaneously transmitting antennas in each transmit scenario may be considered one pair at a time to determine whether the SPLSR (e.g., RF exposure compliance exemption metric) qualifies the transmit scenario for exemption from simultaneous transmission testing (e.g., RF exposure compliance testing).

The SPLSR (e.g., RF exposure compliance exemption metric) for a given transmit scenario may be determined according to the following expression:

$$SPLSR = \frac{{( max [ \frac{{SAR}_{1}}{{SAR}_{limit}} , \frac{{APD}_{1}}{{APD}_{limit}} ] + max [ \frac{{SAR}_{2}}{{SAR}_{limit}} , \frac{{APD}_{2}}{{APD}_{limit}} ] )}^{1.5}}{Dist a n c e} \qquad ( 7 )$$

where SAR₁ and SAR₂ are the SAR values for the 1^{st} and 2^{nd} transmitters, respectively, SARₗᵢₘᵢₜ is the applicable SAR limit, APD₁ and APD₂ are the absorbed power density (APD) values for the 1^{st} and 2^{nd} transmitters, respectively, APDₗᵢₘᵢₜ is the applicable APD limit, and distance is the separation distance between the peak exposure locations of the 1^{st} and 2^{nd} transmitters in millimeters (mm).

In certain cases, when the SPLSR for a given transmit scenario satisfies a condition specified by a standard and/or regulatory body, simultaneous transmission testing for that transmission scenario may be exempted. For example, when SPLSR≤0.04 for all antenna pairs associated with a transmit scenario, then the transmit scenario may qualify for a 1-g SAR test exemption. When SPLSR≤0.10 for all antenna pairs associated with a transmit scenario, then the transmit scenario may qualify for a 10-g SAR test exemption. When the exemption condition(s) associated with the SPLSR exemption procedure is not satisfied, the transmit scenario may have to undergo RF exposure compliance testing.

### Example Transmit Antenna Grouping Using an Optimized RF Exposure Compliance Exemption Procedure

Multi-mode/multi-band UEs have multiple transmit antennas, which can simultaneously transmit in sub-6 GHz bands and bands greater than 6 GHz bands, such as mmWave bands. As described herein, the RF exposure of sub-6 GHz bands may be evaluated in terms of SAR, and the RF exposure of bands greater than 6 GHz may be evaluated in terms of PD. Due to the regulations on simultaneous exposure, the wireless device may limit maximum transmit power for both sub-6 GHz bands and bands greater than 6 GHZ.

In certain cases, although antennas may be positioned in different locations across a UE, a time-averaging algorithm for RF exposure compliance may assume the peak locations of RF exposure (also referred to as RF exposure hotspots) from all transmit antennas are collocated on the UE. Under such an assumption, the total transmit power of all transmit antennas may be limited regardless of the actual exposure scenario (e.g., head exposure, body exposure, or extremity exposure) of separate antennas. For example, suppose the user's hand covers one location on the UE, while RF exposure hotspots from specific antennas are not covered by the user's hand. That is, antennas may contribute to the RF exposure differently depending on the location of the exposure. Enforcing the collocated model may lead to limiting the transmit power of specific antennas whose RF exposure hotspots are not actually covered by the user's hand. That is, the assumption that all RF exposure hotspots from the transmit antennas are collocated for RF exposure compliance may result in a needlessly low transmit power, which may affect uplink performance such as uplink data rates, uplink carrier aggregation, and/or an uplink connection at the edge of a cell.

Aspects of the present disclosure provide various techniques for grouping antennas, for example, to determine RF exposure compliance on a group basis. In certain aspects, the antenna groups may be defined using an RF exposure compliance exemption procedure, such as an SPLSR exemption procedure. The RF exposure compliance exemption procedure may involve computing one or more RF exposure compliance exemption metrics (e.g., SPLSRs) for each transmit scenario supported by a wireless communication device.

In certain aspects, when the RF exposure compliance exemption metrics for a transmit scenario satisfy certain conditions specified by a standard and/or regulatory body, the antennas associated with the transmit scenario may be assigned or allocated to different antenna groups. For example, a pair of antennas may be considered to be spatially separated when the RF exposure compliance exemption metrics for the transmit scenario satisfy the regulatory conditions. With an SPLSR exemption procedure, for instance, a pair of antennas may be considered to be spatially separated, and therefore, assigned to different antenna groups, when SPLSR≤0.02 for head, neck, and truck exposure conditions and when SPLSR≤0.013 for limb exposure conditions.

One technical benefit of assigning antennas to antenna groups is that the antenna groups may be configured and/or operated so as to be mutually exclusive of each other in terms of RF exposure. That is, the RF exposure produced by one antenna group may not contribute to the RF exposure produced by another antenna group, for example, due to the antenna groups being arranged in different locations of the wireless device. The RF exposure compliance and corresponding transmit power levels may be determined separately for each antenna group. The antenna grouping may enable relatively higher transmit power for specific antenna groups. The higher transmit power may provide desirable uplink performance, such as desirable uplink data rates, uplink carrier aggregation, and/or an uplink connection at the edge of a cell.

However, one potential drawback to using an RF exposure compliance exemption procedure, such as SPLSR exemption procedure, to group antennas is that it can take a significant amount of time and/or compute resources to implement the RF exposure compliance exemption procedure for certain types of antennas, such as mmW antennas. For example, implementing the RF exposure compliance exemption procedure for a mmW module may involve computing an RF exposure compliance exemption metric (e.g., an SPLSR) for each beam (e.g., transmit antenna configuration) supported by the mmW module.

In one illustrative example, assuming (i) the wireless communication device supports a mmW module and a sub-6 GHz antenna, (ii) the RF exposure compliance exemption procedure is an SPLSR exemption procedure, and (iii) there are N beams supported by the mmW module, then the SPLSR exemption procedure may involve computing N SPLSR metrics to (i) demonstrate exemption from RF exposure compliance testing for the mmW module and/or sub-6 GHz antenna and (ii) determine one or more antenna groups for the mmW module and sub-6 GHz antenna.

In another illustrative example, assuming (i) the wireless communication device supports a first mmW module capable of transmitting with N/beams and supports a second mmW module capable of transmitting with N2 beams and (ii) the RF exposure compliance exemption procedure is an SPLSR exemption procedure, then the SPLSR exemption procedure may involve computing N1*N2 SPLSR metrics to (i) demonstrate exemption from RF exposure compliance testing for the first mmW module and/or second mmW module and (ii) determine one or more antenna groups for the first mmW module and second mmW module.

Certain aspects of the present disclosure provide various techniques for performing an optimized (or at least reduced) RF exposure compliance exemption procedure to group antennas. Compared to conventional RF exposure compliance exemption procedures, the optimized (or at least reduced) RF exposure compliance exemption procedure described herein may involve computing a reduced number of RF exposure compliance exemption metrics to demonstrate exemption from RF exposure compliance testing for certain antennas of the wireless communication device (e.g., mmW antennas).

For example, in certain aspects, one or more RF exposure maps associated with antennas of the wireless communication device may be obtained for the wireless device. The RF exposure map(s) may be representative of the RF exposure in terms of SAR, PD, and/or APD. In certain aspects, the RF exposure map(s) may indicate one or more locations on at least one surface of the wireless communication device that are associated with one or more maximum RF exposures for certain transmit scenario combinations (e.g., beam combinations).

In certain aspects, one or more RF exposure regions associated with the location(s) that exhibit the maximum RF exposure(s) may be determined based at least in part on the RF exposure map(s). An optimized (or at least reduced) RF exposure compliance exemption procedure may then be performed for at least two antennas of the wireless communication device using the RF exposure region(s). For example, the optimized (or at least reduced) RF exposure compliance exemption procedure may involve computing one or more RF exposure compliance exemption metrics (e.g., SPLSRs) for each respective RF exposure region.

In certain aspects, for at least one of the RF exposure regions, the total number of the RF exposure compliance exemption metrics for the RF exposure region may be less than a total number of the location(s) associated with the RF exposure region. For example, the optimized (or at least reduced) RF exposure compliance exemption procedure described herein may use the RF exposure region(s) to represent the supported number of beams (e.g., N beams) of a mmW module with a smaller number of maximum RF exposure-based regions (e.g., M regions, where M<N). The optimized (or at least reduced) RF exposure compliance exemption procedure may compute RF exposure compliance exemption metrics for the smaller number of maximum RF exposure-based regions in order to perform antenna grouping.

For example, assuming (i) the wireless communication device supports a mmW module and a sub-6 GHz antenna and (ii) there are N beams supported by the mmW module, the optimized (or at least reduced) RF exposure compliance exemption procedure may involve computing M SPLSR metrics to (i) demonstrate exemption from RF exposure compliance testing for the mmW module and/or sub-6 GHz antenna and (ii) determine one or more antenna groups for the mmW module and sub-6 GHz antenna, where M<N.

In another example, assuming the wireless communication device supports a first mmW module with N/beams and supports a second mmW module with N2 beams, then the optimized (or at least reduced) RF exposure compliance exemption procedure may involve computing M1*M2 SPLSR metrics to (i) demonstrate exemption from RF exposure compliance testing for the first mmW module and/or second mmW module and (ii) determine one or more antenna groups for the first mmW module and second mmW module, where M1<N1 and M2<N2.

The apparatus and methods for performing antenna grouping using an optimized (or at least reduced) RF exposure compliance exemption procedure described herein may facilitate improved wireless communication performance (e.g., improved signal quality at the receiver, lower latencies, higher throughput, etc.). The apparatus and methods for performing antenna grouping using an optimized (or at least reduced) RF exposure compliance exemption procedure described herein may also enable improved processing performance, for example, due to the reduced memory size used by the RF exposure map and/or the reduced number of computations used to perform the RF exposure compliance exemption procedure to determine one or more antenna groups.

Note that while certain aspects describe the optimized (or at least reduced) RF exposure compliance exemption procedure being performed to exempt a transmission scenario involving at least one mmW module from RF exposure compliance testing, it should be noted that the optimized (or at least reduced) RF exposure compliance exemption procedure described herein is not limited to mmW antennas and can be used to exempt transmission scenarios involving one or more non-mmW antennas, one or more mmW antennas, or any combination thereof, from RF exposure compliance testing. By way of example, the optimized (or at least reduced) RF exposure compliance exemption procedure can be used to exempt a transmission scenario involving two or more non-mmW antennas (e.g., two or more sub-6 GHz antennas, each of which may support transmission with one or more beams) from RF exposure compliance testing.

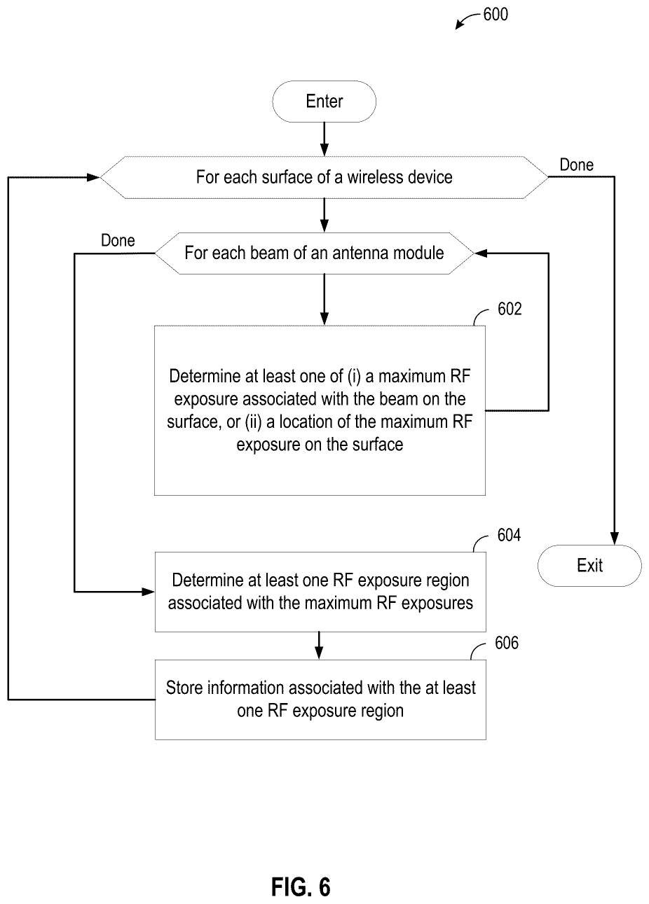

FIG. 6 is a flow diagram illustrating example operations 600 for generating one or more RF exposure regions associated with location(s) on the wireless communication device that exhibit maximum RF exposure for certain transmit scenarios, according to certain aspects of the present disclosure. The operations 600 may be performed using a processing system (e.g., the processing system 502) or another computational device.

The operations 600 may include block 602, block 604, and block 606, all of which may be performed for each surface of a wireless device. At block 602, the processing system may determine, for each beam of an antenna module (e.g., a mmW module), at least one of (i) a maximum RF exposure associated with the beam on the surface, or (ii) a location of the maximum RF exposure on the surface. The maximum RF exposure may be a maximum normalized RF exposure, such as a maximum normalized PD exposure. The maximum RF exposure and/or the location of the maximum RF exposure for each beam may be determined from one or more RF exposure maps for the surface. Such RF exposure maps may indicate one or more locations on the surface of the wireless communication device that are associated with one or more maximum RF exposures.

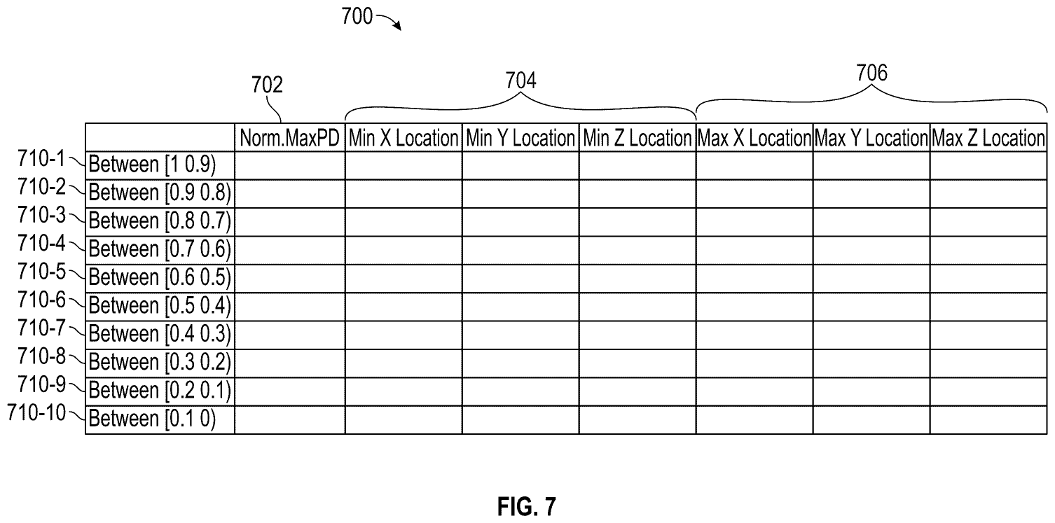

In certain aspects, implementing the operations in block 602 may involve generating (or initializing) an empty matrix or table. The size of the empty matrix or table may be based on the number of maximum normalized RF exposure bins (or interval levels), whether the location is two-dimensional (2D) (e.g., X-Y coordinate) or three-dimensional (3D) (e.g., X-Y-Z coordinate), or a combination thereof. For example, an empty A×B matrix may be generated, where A (e.g., number of rows) is based on the number of normalized RF exposure bins, and B (e.g., number of columns) is based on whether the location of the RF exposure is 2D or 3D. FIG. 7 illustrates an example table 700 with 10 rows 710-1 to 710-10 and 7 columns that can be generated at block 602. In table 700, column 702 may be used to indicate the maximum normalized RF exposures (e.g., maximum normalized PD exposures), columns 704 may be used to indicate the 3D locations of the smallest maximum normalized RF exposures, and columns 706 may be used to indicate the 3D locations of the highest maximum normalized RF exposures. Each row 710 of the table 700 may correspond to a different RF exposure bin, which represents a subrange of maximum normalized RF exposure values within a larger range of maximum normalized RF exposure values. For example, assuming the range of maximum normalized RF exposure values is between 0 and 1 and a 0.1 step size, there may be a total of 10 RF exposure bins. Note, however, that a 0.1 step size is merely an example and that any step size can be used to realize any number of RF exposure bins.

After the empty matrix or table (e.g., table 700) is generated, the operations in block 602 may involve obtaining the normalized RF exposure (e.g., normalized PD exposure) for the 1^{st} beam or beam pair supported by the antenna module. The processing system may identify the 1^{st} beam's maximum normalized RF exposure for that surface and maximum normalized RF exposure's location. If the 1^{st} beam is the initial beam being processed, then the processing system may populate the maximum normalized RF exposure value in the table row 710 corresponding to RF exposure value's range. For example, if the maximum normalized RF exposure value is 0.7, then this data may be populated in row 710-3 of table 700. Additionally, the min location (X-Y-Z) data and the max location (X-Y-Z) data may be the location of the maximum normalized RF exposure value and may be populated in row 710-3 of table 700.

For each subsequent beam/beam pair that is evaluated, the processing system may repeat the process of identifying the beam's maximum normalized RF exposure for that surface. The processing system may identify the respective row 710 of the table 700 corresponding to the value of the beam's maximum normalized RF exposure and update the columns 702, 704, and 706 corresponding to the identified row 710 based on the following: (1) norm.maxPD=max (current value, previous value); (2) Min X/Y/Z location=min (current value, previous value); and (3) Max X/Y/Z location=max (current value, previous value). The processing system may repeat these steps for each surface of each antenna module. At the end, the processing system may obtain a populated matrix for each antenna module and exposure surface being evaluated. Note that the populated matrix may be a fully populated matrix (e.g., there is data for each row of the matrix) or a partially populated matrix (e.g., at least some of the rows may not have populated data). Note as surfaces are planes, one of the X/Y/Z coordinates may be same so the definitions of the remaining two coordinates may get updated accordingly. In this example, obtaining Min X/Y/Z and Max X/Y/Z locations is approximating the maximum RF exposure regions for each row 710 of the table 700 (i.e., each RF exposure bin range of 0.1 step size) with a rectangle. As an example, on a Z-surface, rectangular region's coordinates are given by (minX, minY), (minX, maxY), (maxX, maxY) and (maxX, minY). Alternatively, the individual X/Y/Z maximum RF exposure location for each beam belonging to each row 710 of the table 700 (i.e., all beams that belong to each RF exposure bin range of 0.1 step size) may be stored and encompassed into a contour boundary in any suitable shape (e.g., rectangle, polygon, circle, etc.). Further, the surfaces may be characterized or represented with a configuration other than a plane. For example, a curved surface, etc. may be used instead. While descriptions above relate to the creation and population of a table, it will be understood that the concepts described herein may be implemented without such data structure or with a substitute data structure(s).

At block 604, the processing system may determine at least one RF exposure region associated with the locations on the surface corresponding to the maximum RF exposures. For example, the processing system may use the values in the populated matrix corresponding to the surface to generate the RF exposure region associated with the locations corresponding to the maximum RF exposures. In certain aspects, the RF exposure region may have a contour that represents the boundary around the locations corresponding to the maximum RF exposures. For example, all points inside the boundary may have a value higher (greater) than the contour threshold. In certain cases, the processing system may approximate the boundary of the contour as a rectangle or any other suitable polygon. For example, the processing system may determine the rectangular boundary that encompasses the contour boundary of the RF exposure region. Any polygonal shape or the contour shape itself could be used for the boundary of the RF exposure region. Other shapes may use more memory to store the region boundary, whereas a rectangular boundary may use values of two start coordinates, a length, and a breadth. For example, an area representing a 0.87 contour of an antenna module for a right surface of a wireless device may be bounded by a rectangular region with coordinates (minX, minY), (maxX, minY), (maxX, max Y), and (minX, max Y). Note, however, that this is merely an example and that any other suitable polygonal shape, elliptical shape (e.g., circle), or the contour shape itself can be used for the boundary of the RF exposure region.

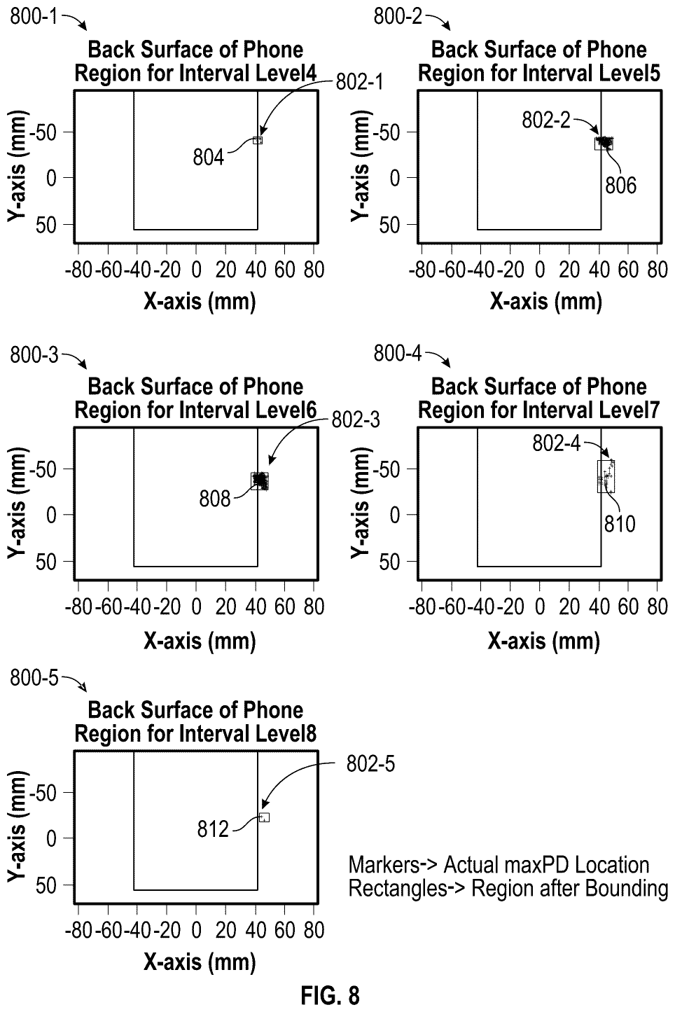

In certain aspects, the RF exposure region may be indicated on one or more RF exposure maps for the wireless communication device. FIG. 8 illustrates example RF exposure maps 800-1 to 800-5 that include indications of RF exposure regions 802-1 to 802-5, respectively, for a back surface of a wireless device. Here, RF exposure map 800-1 indicates an RF exposure region 802-1 associated with locations 804 of maximum RF exposures on a back surface of the wireless communication device for a first interval level (or row) of the populated table; RF exposure map 800-2 indicates an RF exposure region 802-2 associated with locations 806 of maximum RF exposures on the back surface of the wireless communication device for a second interval level (or row) of the populated table; RF exposure map 800-3 indicates an RF exposure region 802-3 associated with locations 808 of maximum RF exposures on the back surface of the wireless communication device for a third interval level (or row) of the populated table; RF exposure map 800-4 indicates an RF exposure region 802-4 associated with locations 810 of maximum RF exposures on the back surface of the wireless communication device for a fourth interval level (or row) of the populated table; and RF exposure map 800-5 indicates an RF exposure region 802-5 associated with locations 812 of maximum RF exposures on the back surface of the wireless communication device for a fifth interval level (or row) of the populated table.

Note that while FIG. 8 shows a separate RF exposure map for each interval level (or row) of the populated table, in certain aspects, the RF exposure maps 800 may be combined to generate a total exposure map for the back surface of the wireless device. Additionally, note that, in some cases, certain beams associated with a mmW module may not have an RF exposure value that falls within certain interval levels (or rows) of the populated table. Thus, in such cases, an RF exposure region as well as locations of maximum RF exposures may not be indicated on an RF exposure map for those interval levels.

At block 606, the processing system may store information associated with the at least one RF exposure region, e.g., in one or more memories (e.g., one or more memories 510) and/or any other suitable storage devices. Such information may include the RF exposure map, the information determined in block 602, or any combination thereof (e.g., in a database, memory, etc.).

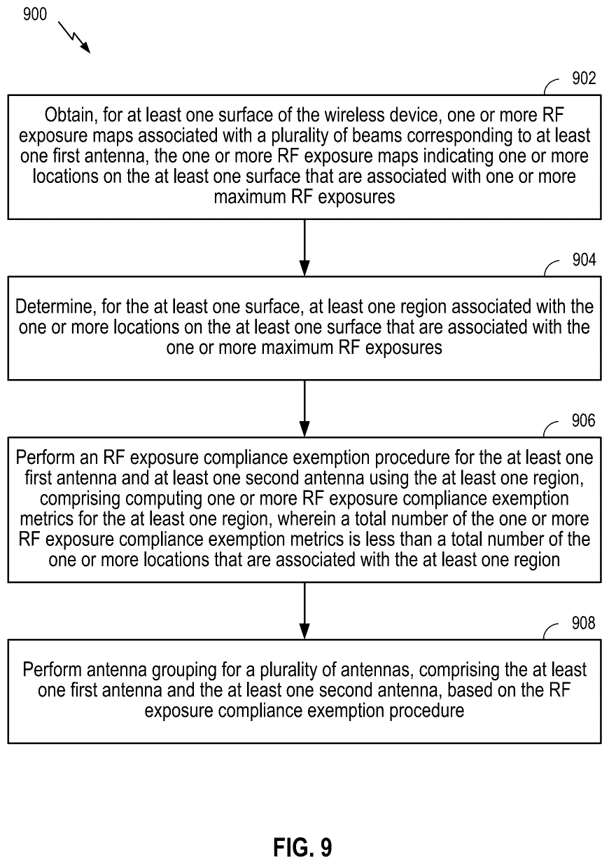

FIG. 9 is a flow diagram illustrating example operations 900 for performing antenna grouping based on an optimized (or at least reduced) RF exposure compliance exemption procedure, according to certain aspects of the present disclosure. The operations 900 may be performed using a processing system (e.g., the processing system 502) or any other computational device. The operations 900 may optionally begin at block 902, where the processing system may obtain, for at least one surface of the wireless device, one or more RF exposure maps associated with a plurality of beams corresponding to at least one first antenna. The one or more RF exposure maps may indicate one or more locations on the at least one surface that are associated with one or more maximum RF exposures.

At block 904, the processing system determines, for the at least one surface, at least one region associated with the one or more locations on the at least one surface that are associated with the one or more maximum RF exposures.

At block 906, the processing system performs an RF exposure compliance exemption procedure for the at least one first antenna and at least one second antenna using the at least one region. Performing the RF exposure compliance exemption procedure may involve computing one or more RF exposure compliance exemption metrics for the at least one region. A total number of the one or more RF exposure compliance exemption metrics may be less than a total number of the one or more locations that are associated with the at least one region.

At block 908, the processing system performs antenna grouping for a plurality of antennas, comprising the at least one first antenna and the at least one second antenna, based on the RF exposure compliance exemption procedure. In certain aspects, the processing system may store information associated with the antenna grouping (e.g., number of antenna groups, which antennas are included in each antenna group for each transmit scenario, among other information) in one or more memories (e.g., one or more memories 510) and/or any other suitable storage device(s). The stored information may be provided to a wireless device (e.g., a UE, such as UE 120) to enable the wireless device to transmit signals according to the antenna grouping (e.g., antennas 252) in compliance with an RF exposure limit. For example, information associated with the antenna grouping may be stored in the wireless device during manufacture or provisioning of the wireless device and thereafter accessed by the wireless device during operation.

In certain aspects, determining the at least one region may include: determining a plurality of RF exposure bins for the at least one surface, each RF exposure bin representing a subrange of maximum RF exposure values within a larger range of maximum RF exposure values; for each of the plurality of RF exposure bins, associating the RF exposure bin with information indicating (i) a maximum RF exposure value among the plurality of beams within the respective subrange of maximum RF exposure values for the RF exposure bin and (ii) a location of the maximum RF exposure value on the at least one surface of the wireless device; and determining the at least one region based on the information associated with at least some of the plurality of RF exposure bins. The location of the maximum RF exposure value may be a 2D location or a 3D location.

In certain aspects, the at least one region may be associated with a contour that is representative of a boundary around the one or more locations. The contour may have a polygonal shape (e.g., rectangle) or an elliptical shape (e.g., circle). In some aspects, each of the one or more RF exposure compliance exemption metrics may be associated with a respective point on the contour.

In certain aspects, the at least one first antenna may include a first mmW antenna capable of transmitting using the plurality of beams, and the at least one second antenna may include a non-mmW antenna (e.g., a sub-6 GHz antenna).

In certain aspects, the at least one first antenna may include a first mmW antenna capable of transmitting using the plurality of beams, and the at least one second antenna may include a second mmW antenna capable of transmitting using another plurality of beams.

In certain aspects, the at least one first antenna may include a first non-mmW antenna and the at least one second antenna may include a second non-mmW antenna.

In certain aspects, performing the antenna grouping may include determining one or more antenna groups for the plurality of antennas. In these aspects, determining the one or more antenna groups may include determining a first antenna group including the at least one first antenna and a second antenna group including the at least one second antenna when the one or more RF exposure compliance exemption metrics satisfy a predetermined condition.

In certain aspects, the RF exposure compliance exemption procedure may include an SPLSR compliance exemption procedure. In these aspects, the one or more RF exposure compliance exemption metrics may include one or more SPLSRs.

In certain aspects, performing the optimized (or at least reduced) RF exposure compliance exemption procedure described herein may enable the processing system to compute a reduced number of RF exposure compliance exemption metrics corresponding to the smaller number of maximum RF exposure-based regions in order to perform antenna grouping.

For example, assuming (i) the wireless communication device supports a mmW module and a sub-6 GHz antenna and (ii) there are N beams supported by the mmW module, the processing system may compute M SPLSR metrics to (i) demonstrate exemption from RF exposure compliance testing for the mmW module and/or sub-6 GHZ antenna and (ii) determine one or more antenna groups for the mmW module and sub-6 GHz antenna, where M<N.

In another example, assuming the wireless communication device supports a first mmW module with N/beams and a second mmW module with N2 beams, then the processing system may compute M1*M2 SPLSR metrics to (i) demonstrate exemption from RF exposure compliance testing for the first mmW module and/or second mmW module and (ii) determine one or more antenna groups for the first mmW module and second mmW module, where M1<N1 and M2<N2.

Advantageously, the techniques described herein may reduce the number of involved computations from (number of beams+beam pairs per module)\hat{ }(number of modules) to number of contours*number of modules*worst location points (minimum distance from max norm.exp location of other antenna) on contour rectangles thereby significantly reducing the computation time while sufficiently accounting for changes in amplitudes and location of hotspots (for RF exposure compliance exemption criteria). Additionally, the techniques described herein may allow for treating mmW modules or antenna arrays, such as FR3 antennas, similarly to sub-6 GHz antennas, such that the RF exposure limits computed by time-averaging algorithms can be optimized when the RF exposure compliance exemption criteria (e.g., SPLSR criteria) is met. For example, if 2 mmW modules are spatially separated via SPLSR criteria, then the available high power margin can be increased (e.g., the available high power margin may be doubled in cases where the past exposure is similar between two antenna groups). Additionally, the techniques described herein may allow for controlling the number of maximum normalized RF exposure bins of a table/matrix used to generate an RF exposure map for a given surface. For example, the number of maximum normalized RF exposure bins can be increased/decreased in order to optimize (or at least improve) the available margin region bounding. As SPLSR may be dependent on both amplitude and separation distance, the spatial separation can be leveraged with minimum conservativeness.

While the examples depicted in FIGS. 1-9 are described herein with respect to a computing device performing the various methods for providing RF exposure compliance to facilitate understanding, aspects of the present disclosure may also be applied to other wireless devices, such as a wireless station, an access point, a base station and/or a customer premises equipment (CPE), performing the RF exposure compliance described herein. Further, while certain examples are described with respect to communications between the UE (or other wireless device) and a network entity, the UE or other wireless device may be communicating with a device other than a network entity, for example another UE or with another device in a user's home that is not a network entity, for example.

It will be appreciated that the compressed RF exposure map described herein may enable desirable wireless communication performance, such as reduced latencies, increased uplink data rates, and/or an uplink connection at the edge of a cell. The compressed RF exposure map described herein may provide efficient RF exposure compliance with region-specific RF exposure values relative to an RF exposure map.

### Example Computing Device

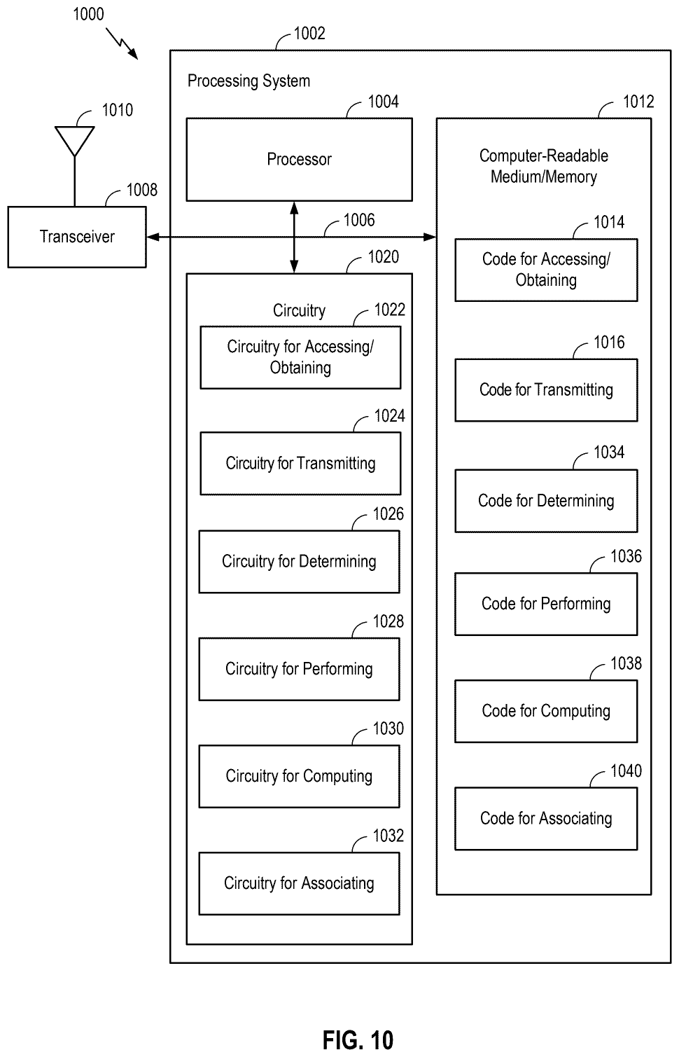

FIG. 10 illustrates a computing device 1000 that may include various components (e.g., corresponding to means-plus-function components) configured to perform operations for the techniques disclosed herein, such as the operations illustrated in FIG. 6, the operations illustrated in FIG. 9, or other operations described herein for providing RF exposure compliance. The computing device 1000 includes a processing system 1002, which may be coupled to a transceiver 1008 (e.g., a transmitter and/or a receiver). The transceiver 1008 is configured to transmit and receive signals for the computing device 1000 via an antenna 1010, such as the various signals as described herein. The processing system 1002 may be configured to perform processing functions for the computing device 1000, including processing signals received and/or to be transmitted by the computing device 1000. In some examples, the antenna 1010 is omitted. In some such examples, the transceiver 1008 is also omitted or is configured for wireline communication.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the computing device 1000 to perform the operations 600 illustrated in FIG. 6, the operations 900 illustrated in FIG. 9, or other operations for performing the various techniques discussed herein for providing RF exposure compliance. In certain aspects, computer-readable medium/memory 1012 stores code for accessing (or obtaining) 1014, optionally code for transmitting (or outputting) 1016, code for determining 1034, code for performing 1036, code for computing 1038, code for associating 1040, or any combination thereof.

In certain aspects, the processing system 1002 has circuitry 1020 configured to implement the code stored in the computer-readable medium/memory 1012. In certain aspects, the circuitry 1020 is coupled to the processor 1004 and/or the computer-readable medium/memory 1012 via the bus 1006. For example, the circuitry 1020 includes circuitry for accessing (or obtaining) 1022, optionally circuitry for transmitting (or outputting) 1024, circuitry for determining 1026, circuitry for performing 1028, circuitry for computing 1030, circuitry for associating 1032, or any combination thereof.

In some examples, means for transmitting or sending (or means for outputting for transmission) may include the transceivers 254 and/or antenna(s) 252 of the UE 120 illustrated in FIG. 2 and/or interface 514 illustrated in FIG. 5 and/or transceiver 1008 and antenna 1010 of the computing device 1000 in FIG. 10.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission or to an I/O port. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception or from the I/O port. In various aspects, an RF front end may include various components, including transmit and receive processors, transmit and receive MIMO processors, modulators, demodulators, and the like, such as depicted in the examples in FIG. 2.

In some examples, means for accessing, means for determining, means for performing, means for computing, means for associating, and/or means for obtaining, may include various processing system components, such as: the processor 1004 in FIG. 10; aspects of the UE 120 depicted in FIG. 2, including receive processor 258, transmit processor 264, TX MIMO processor 266, and/or controller/processor 280; or the processor 508 in FIG. 5.

### Example Aspects

Implementation examples are described in the following numbered clauses:

Clause 1: A method for wireless device assessment by a computing device, comprising: obtaining, for at least one surface of a wireless device, one or more radio frequency (RF) exposure maps associated with a plurality of beams corresponding to at least one first antenna, the one or more RF exposure maps indicating one or more locations on the at least one surface that are associated with one or more maximum RF exposures; determining, for the at least one surface, at least one region associated with the one or more locations on the at least one surface that are associated with the one or more maximum RF exposures; performing an RF exposure compliance exemption procedure for the at least one first antenna and at least one second antenna using the at least one region, comprising computing one or more RF exposure compliance exemption metrics for the at least one region, wherein a total number of the one or more RF exposure compliance exemption metrics is less than a total number of the one or more locations that are associated with the at least one region; and performing antenna grouping for a plurality of antennas, comprising the at least one first antenna and the at least one second antenna, based on the RF exposure compliance exemption procedure.

Clause 2: The method of Clause 1, wherein determining the at least one region comprises: determining a plurality of RF exposure bins for the at least one surface, each RF exposure bin representing a subrange of maximum RF exposure values within a larger range of maximum RF exposure values; for each of the plurality of RF exposure bins, associating the RF exposure bin with information indicating (i) a maximum RF exposure value among the plurality of beams within the respective subrange of maximum RF exposure values for the RF exposure bin and (ii) a location of the maximum RF exposure value on the at least one surface of the wireless device; and determining the at least one region based on the information associated with at least some of the plurality of RF exposure bins.

Clause 3: The method of Clause 2, wherein the location of the maximum RF exposure value is a three-dimensional (3D) location.

Clause 4: The method in accordance with any of Clauses 1-3, wherein the at least one region is associated with a contour that is representative of a boundary around the one or more locations.

Clause 5: The method of Clause 4, wherein the contour has a polygonal shape.

Clause 6: The method of Clause 5, wherein the polygonal shape is a rectangle.

Clause 7: The method of Clause 4, wherein the contour has an elliptical shape.

Clause 8: The method in accordance with any of Clauses 4-7, wherein each of the one or more RF exposure compliance exemption metrics is associated with a respective point on the contour.

Clause 9: The method in accordance with any of Clauses 1-8, wherein the at least one first antenna comprises a first millimeter wave (mmW) antenna capable of transmitting using the plurality of beams.

Clause 10: The method of Clause 9, wherein the at least one second antenna comprises a non-mmW antenna.

Clause 11: The method of Clause 9, wherein the at least one second antenna comprises a second mmW antenna capable of transmitting using another plurality of beams.

Clause 12: The method in accordance with any of Clauses 1-8, wherein: the at least one first antenna comprises a first non-millimeter wave (mmW) antenna; and the at least one second antenna comprises a second non-mmW.

Clause 13: The method in accordance with any of Clauses 1-12, wherein performing the antenna grouping comprises determining one or more antenna groups for the plurality of antennas.

Clause 14: The method of Clause 13, wherein determining the one or more antenna groups comprises determining a first antenna group including the at least one first antenna and a second antenna group including the at least one second antenna when the one or more RF exposure compliance exemption metrics satisfy a predetermined condition.

Clause 15: The method in accordance with any of Clauses 1-14, wherein: the RF exposure compliance exemption procedure comprises a specific absorption ratio (SAR)-to-peak location separation ratio (SPLSR) compliance exemption procedure; and the one or more RF exposure compliance exemption metrics comprise one or more SPLSRs.

Clause 16: An apparatus comprising: one or more memories collectively storing executable instructions; and one or more processors coupled to the one or more memories, the one or more processors being collectively configured to execute the executable instructions and cause the apparatus to perform a method in accordance with any of Clauses 1-15.

Clause 17: An apparatus comprising means for performing a method in accordance with any of Clauses 1-15.

Clause 18: A non-transitory computer-readable medium comprising computer-executable instructions that, when executed by one or more processors of a processing system, cause the processing system to perform a method in accordance with any of Clauses 1-15.

Clause 19: A computer program product embodied on a computer-readable storage medium comprising code for performing a method in accordance with any of Clauses 1-15.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a closed subscriber group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a customer premises equipment (CPE), a cellular phone, a smart phone, a personal digital assistant (PDA), a wireless modem, a wireless device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within the entity's service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, generating, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6 and/or FIG. 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless device assessment by a computing device, comprising:
obtaining, for at least one surface of a wireless device, one or more radio frequency (RF) exposure maps associated with a plurality of beams corresponding to at least one first antenna, the one or more RF exposure maps indicating one or more locations on the at least one surface that are associated with one or more maximum RF exposures;
determining, for the at least one surface, at least one region associated with the one or more locations on the at least one surface that are associated with the one or more maximum RF exposures;
performing an RF exposure compliance exemption procedure for the at least one first antenna and at least one second antenna using the at least one region, comprising computing one or more RF exposure compliance exemption metrics for the at least one region, wherein a total number of the one or more RF exposure compliance exemption metrics is less than a total number of the one or more locations that are associated with the at least one region; and
performing antenna grouping for a plurality of antennas, comprising the at least one first antenna and the at least one second antenna, based on the RF exposure compliance exemption procedure.

2. The method of claim 1, wherein determining the at least one region comprises:
determining a plurality of RF exposure bins for the at least one surface, each RF exposure bin representing a subrange of maximum RF exposure values within a larger range of maximum RF exposure values;
for each of the plurality of RF exposure bins, associating the RF exposure bin with information indicating (i) a maximum RF exposure value among the plurality of beams within the respective subrange of maximum RF exposure values for the RF exposure bin and (ii) a location of the maximum RF exposure value on the at least one surface of the wireless device; and
determining the at least one region based on the information associated with at least some of the plurality of RF exposure bins.

3. The method of claim 2, wherein the location of the maximum RF exposure value is a three-dimensional (3D) location.

4. The method of claim 1, wherein the at least one region is associated with a contour that is representative of a boundary around the one or more locations.

5. The method of claim 4, wherein the contour has a polygonal shape.

6. The method of claim 5, wherein the polygonal shape is a rectangle.

7. The method of claim 4, wherein the contour has an elliptical shape.

8. The method of claim 4, wherein each of the one or more RF exposure compliance exemption metrics is associated with a respective point on the contour.

9. The method of claim 1, wherein the at least one first antenna comprises a first millimeter wave (mmW) antenna capable of transmitting using the plurality of beams.

10. The method of claim 9, wherein the at least one second antenna comprises a non-mmW antenna.

11. The method of claim 9, wherein the at least one second antenna comprises a second mmW antenna capable of transmitting using another plurality of beams.

12. The method of claim 1, wherein:
the at least one first antenna comprises a first non-millimeter wave (mmW) antenna; and
the at least one second antenna comprises a second non-mmW.

13. The method of claim 1, wherein performing the antenna grouping comprises determining one or more antenna groups for the plurality of antennas.

14. The method of claim 13, wherein determining the one or more antenna groups comprises determining a first antenna group including the at least one first antenna and a second antenna group including the at least one second antenna when the one or more RF exposure compliance exemption metrics satisfy a predetermined condition.

15. The method of claim 1, wherein:
the RF exposure compliance exemption procedure comprises a specific absorption ratio (SAR)-to-peak location separation ratio (SPLSR) compliance exemption procedure; and
the one or more RF exposure compliance exemption metrics comprise one or more SPLSRs.

16. An apparatus for wireless device assessment, comprising:
one or more memories collectively storing executable instructions; and
one or more processors coupled to the one or more memories, the one or more processors being collectively configured to execute the executable instructions to cause the apparatus to:
obtain, for at least one surface of a wireless device, one or more radio frequency (RF) exposure maps associated with a plurality of beams corresponding to at least one first antenna, the one or more RF exposure maps indicating one or more locations on the at least one surface that are associated with one or more maximum RF exposures;
determine, for the at least one surface, at least one region associated with the one or more locations on the at least one surface that are associated with the one or more maximum RF exposures;
perform an RF exposure compliance exemption procedure for the at least one first antenna and at least one second antenna using the at least one region, wherein, to perform the RF exposure compliance exemption procedure, the one or more processors are collectively configured to execute the instructions to cause the apparatus to compute one or more RF exposure compliance exemption metrics for the at least one region, wherein a total number of the one or more RF exposure compliance exemption metrics is less than a total number of the one or more locations that are associated with the at least one region; and
perform antenna grouping for a plurality of antennas, comprising the at least one first antenna and the at least one second antenna, based on the RF exposure compliance exemption procedure.

17. The apparatus of claim 16, wherein, to determine the at least one region, the one or more processors are collectively configured to execute the instructions to cause the apparatus to:
determine a plurality of RF exposure bins for the at least one surface, each RF exposure bin representing a subrange of maximum RF exposure values within a larger range of maximum RF exposure values;
for each of the plurality of RF exposure bins, associate the RF exposure bin with information indicating (i) a maximum RF exposure value among the plurality of beams within the respective subrange of maximum RF exposure values for the RF exposure bin and (ii) a location of the maximum RF exposure value on the at least one surface of the wireless device; and
determine the at least one region based on the information associated with at least some of the plurality of RF exposure bins.

18. The apparatus of claim 16, wherein the at least one region is associated with a contour that is representative of a boundary around the one or more locations.

19. The apparatus of claim 18, wherein each of the one or more RF exposure compliance exemption metrics is associated with a respective point on the contour.

20. An apparatus for wireless device assessment, comprising:
means for obtaining, for at least one surface of a wireless device, one or more radio frequency (RF) exposure maps associated with a plurality of beams corresponding to at least one first antenna, the one or more RF exposure maps indicating one or more locations on the at least one surface that are associated with one or more maximum RF exposures;
means for determining, for the at least one surface, at least one region associated with the one or more locations on the at least one surface that are associated with the one or more maximum RF exposures;
means for performing an RF exposure compliance exemption procedure for the at least one first antenna and at least one second antenna using the at least one region, wherein the means for performing comprises means for computing one or more RF exposure compliance exemption metrics for the at least one region, wherein a total number of the one or more RF exposure compliance exemption metrics is less than a total number of the one or more locations that are associated with the at least one region; and
means for performing antenna grouping for a plurality of antennas, comprising the at least one first antenna and the at least one second antenna, based on the RF exposure compliance exemption procedure.
